(19) United States
(12) Patent Application Publication
(10) Pub. No.: US 2021/0214115 A1
(43) Pub. Date: Jul. 15, 2021

(54) PROCESS FOR THE MANUFACTURE OF DUAL-CHAMBER CONTAINERS FOR FLUID PRODUCTS OF THE MEDICAL, PHARMACEUTICAL, COSMETIC TYPE OR THE LIKE, AND RELATED STRIP

(71) Applicant: Lameplast, S.r.l.., Novi di Modena (MO) (IT)

(72) Inventors: Filippo FANGAREZZI, an Martino di Mugnano (MO) (IT); Davide ANDREETTO, Este (PD) (IT); Enrico SALVARANI, Carpi (MO) (IT)

(21) Appl. No.: 17/052,869

(22) PCT Filed: May 5, 2020
(86) PCT No.: PCT/IB2020/000341

§ 371 Date: Nov. 4, 2020

(30) Foreign Application Priority Data
May 7, 2019 (IT) 102019000006598

(51) Int. Cl. B65D 1/09; B65D 81/32; B65B 3/00; A61J 1/06; B29C 49/04; B29C 49/22; B29C 49/42

(52) U.S. Cl. CPC B65D 1/09; B65D 81/3277; B65B 3/003; A61J 1/065; B29K 2023/12; B29C 49/22; B29C 49/4273; B29K 2023/06; B29C 49/04

(57) ABSTRACT

Process for the manufacture of dual-chamber containers (1) includes steps of:
shaping one layer of a plastic material to form at least one semi-finished product (2);
closing the semi-finished product (2) inside a forming mould (3);
blowing an expansion gas to make the semi-finished product (2) adhere to the forming mould (3) to form a strip (6) comprising at least one pair of vials (7a, 7b), wherein each of the vials (7a, 7b) is provided with:
   a hollow body (9) comprising a substantially flat first wall (8a) and a substantially curved second wall (8b);
   a closed delivery neck (12); and
   an open bottom tang (14);

and wherein the hollow bodies (9) are joined together through a folding attachment portion (11);
folding the pair of vials (7a, 7b) around the folding attachment portion (11) between an extended configuration, wherein the first walls (8a) are substantially coplanar, and a configuration of use, wherein the first walls (8a) are facing each other and brought close to each other to obtain a dual-chamber container (1).

### FIELD OF INVENTION

The present invention relates to a process for the manufacture of dual-chamber containers for fluid products of the medical, pharmaceutical, cosmetic type or the like and related strip.

### BACKGROUND

Within the pharmaceutical and cosmetic industry, but not exclusively, the use is known of different types of single-dose or multi-dose containers, generally manufactured and distributed in the form of strips.

In this regard, it is specified that a strip consists of a group of containers locked together and joined along special weakened-section connection lines that can be easily torn.

For some particular applications, it is necessary that the fluid to be applied is prepared extemporaneously, mixing together the individual components only upon the actual use thereof.

For this purpose, special containers have been designed in which, by means of a separating partition, there is the division into two or more compartments intended to contain different fluid products.

Dual-chamber containers are known from patents EP2313320 and EP2326573 made using moulding techniques such as injection moulding, using polymeric materials, such as polyethylene or polypropylene.

Injection moulding takes place inside special moulds, which consist of two or more half-shells, adapted to shape the outer surface of the containers and into which one or more cores can be fitted, adapted to shape the inner surface of the containers.

Through this method, the plastic material in the molten state is injected under pressure inside the moulds, in order to fill the gap which is defined between the half-shells and the cores.

When the plastic material is solidified, the mould is opened and the strip of containers is removed from their cores.

Injection moulding, however, considerably limits the choice of materials that can be used and, in particular, rules out the possibility of making multilayer containers.

The latter are increasingly used for the packaging of pharmaceutical, cosmetic products, etc., as they enable the final container to be given particular functions and properties (barrier properties, heat retention properties, etc.).

This type of container is usually made by blow moulding.

Blow moulding involves, in fact, the extrusion of a semi-finished product in plastic material through a die, which can be provided with a special multi-channel head able to make different plastic materials flow in order to form a multilayer semi-finished product.

### SUMMARY OF THE INVENTION

The main aim of the present invention is to devise a process for the manufacture of dual-chamber containers for fluid products of the medical, pharmaceutical, cosmetic type or the like and related strip, which are of simple and immediate practical application.

Another object of the present invention is to devise a process for the manufacture of dual-chamber containers for fluid products of the medical, pharmaceutical, cosmetic type or the like and related strip which allow giving special properties and functions to the final container.

Another object of the present invention is to devise a process for the manufacture of dual-chamber containers for fluid products of the medical, pharmaceutical, cosmetic type or the like and related strip, which allow overcoming the aforementioned drawbacks of the prior art in the ambit of a simple, rational, easy, effective to use and low cost solution.

The objects set out above are achieved by the present process for the manufacture of dual-chamber containers for fluid products of the medical, pharmaceutical, cosmetic type or the like having the characteristics of claim 1.

The objects set out above are achieved by the present strip of dual-chamber containers for fluid products of the medical, pharmaceutical, cosmetic type or the like having the characteristics of claim 10.

### BRIEF DESCRIPTION OF THE DRAWINGS

Other characteristics and advantages of the present invention will be more evident from the description of a preferred, but not exclusive, embodiment of a process for the manufacture of dual-chamber containers for fluid products of the medical, pharmaceutical, cosmetic type or the like and related strip, illustrated as an indication, but not limited to, in the attached tables of drawings in which:

FIGS. 1-8 illustrate steps in a process according a first embodiment of the invention wherein:

FIG. 1 is an exploded perspective view of a die F and forming mould 3 for deforming a semi-finished product 2;

FIG. 2 is an enlarged cross-sectional view of the semi-finished product positioned between the open mould halves 4, 5;

FIG. 3 is an enlarged cross-sectional view of the semi-finished product between the closed mould halves and being deformed by an expansion gas fed in through a nozzle P to form a strip of vials;

FIG. 4 is a perspective and partial sectional view of an injector J having two channels C1, C2 for delivering two fluid products to respective containment chambers of the vials in the strip;

FIG. 5 is a perspective and partial sectional view of two welding elements P sealing the bottom tangs of the vials in the strip;

FIG. 6 is an axonometric view of the strip;

FIG. 7 represents a further step in the process wherein a pair of vials separated from the strip are folded together;

FIG. 8 is an axonometric view of the dual-chamber container obtained by the process shown in FIGS. 1-7;

FIGS. 9-14 illustrate steps in a process according to a second embodiment of the invention wherein:

FIG. 9 is a perspective view of a strip of vials;

FIG. 10 is a perspective view of a pair of vials prior to folding;

FIG. 11 is a perspective view of the pair of vials during the folding step to form a dual-chamber container;

FIG. 12 is a perspective and partial sectional view of an injector J filling a plurality of dual-chamber containers;

FIG. 13 is a perspective and partial cut-away view of a pair of welding elements P sealing the bottom tangs of the filled containers;

FIG. 14 is a perspective view of one of the filled and sealed dual-chamber containers, obtained by the process shown in FIGS. 9-13.

### DETAILED DESCRIPTION

With particular reference to these figures, reference numeral 1 globally indicates a dual-chamber container for fluid products of the medical, pharmaceutical, cosmetic type or the like.

In this regard, it is specified that the words “fluid products” are used here not only to refer to liquid products but also to viscous products, e.g. in paste and gel form, and powdered products, in particular very fine powders with good flowability.

The container 1 can be obtained by means of the manufacturing process according to the present invention.

The process comprises a first phase which consists in shaping through a die F at least one layer of a plastic material to form at least one substantially tubular semi-finished product 2 provided with a first extremity 2a and with a second extremity 2b.

The first extremity 2a is placed in a distal position with respect to the die F while the second extremity 2b is in the proximity of the die F.

The plastic material used to form the semi-finished product 2 can be selected out of polyethylene, polypropylene or any other material adapted to be processed according to the process of the present invention.

The shaping of the semi-finished product 2 is carried out by extrusion and comprises the extrusion of the layer of a plastic material through the die F.

Advantageously, the shaping phase can comprise the extrusion of two or more plastic materials through the die F to obtain a multilayer semi-finished product 2.

The combination of several plastic materials, in fact, can give the final container particular characteristics depending on the customers' needs, while preserving the quality of the fluid product it contains.

For example, the barrier properties of the container may be upgraded, the compressibility thereof may be improved as well as a particular color shade may be given thereto.

Furthermore, from the multilayer semi-finished product 2 may be obtained containers 1 which are more resistant to the high temperatures required for sterilization or to humidity and gases.

For this purpose, the die F can be provided with a special multi-channel head that allows for the simultaneous extrusion of several plastic materials. The semi-finished product 2 is therefore closed inside a forming mould 3 which comprises at least two half-shells 4, 5.

The half-shells 4, 5 are shaped in such a way that, when the semi-finished product 2 is closed in the forming mould 3, the first extremity 2a of the semi-finished product 2 is closed while the second extremity 2b remains in fluidic connection with a pneumatic nozzle P.

Through the second extremity 2b, an expansion gas is blown to make the semi-finished product 2 adhere to the forming mould 3 to form at least one strip 6 comprising at least one pair of vials 7a, 7b.

Filling with expansion gas, therefore, causes the deformation of the semi-finished product 2 and the consequent adhesion thereof to the internal walls of the half-shells 4, 5.

This way, each of the above mentioned vials 7a, 7b is provided with at least one hollow body 9, defining at least one containment chamber 10 of a fluid product and comprising a substantially flat first wall 8a and a substantially curved second wall 8b.

In more detail, the forming mould 3 comprises a substantially flat first half-shell 4 which is adapted to define the first wall 8a and a second half-shell 5 provided with cavities 5a which are adapted to define the second wall 8b.

In addition, the forming mould 3 is shaped so that the hollow bodies 9 of the aforementioned pair of vials 7a, 7b are joined together through a folding attachment portion 11.

At the first extremity 2a, the walls 8a, 8b define at least one closed delivery neck 12.

In particular, the forming mould 3 is shaped so as to provide each of the vials 7a, 7b with a closure cap 13 that can be removed by tearing it off from the delivery neck 12.

At the second extremity 2b, on the other hand, the walls 8a, 8b define at least one open bottom tang 14.

In order to allow the blowing of the expansion gas, the forming mould 3 allows shaping the semi-finished product 2 to define a fluidic connecting duct that connects the bottom tangs 14 to the pneumatic nozzle P.

Once the forming mould 3 has been opened, the connecting duct is waste material and needs to be removed from the bottom tangs 14.

The process, therefore, comprises the phase of removing the connecting duct from the bottom tangs 14.

Removal is defined by means of methods known in the industry, e.g. by parting (with cutting-off machines, circular saws or similar tools), cutting (e.g. by laser or other cutting tools), or shearing (with shearing machines or the like).

This way, each bottom tang 14 defines an opening 10a which allows the fluid to be introduced into the containment chamber 10.

At this point the fluid product is introduced into the containment chambers 10 through the bottom tangs 14.

The hollow bodies 9 are thus filled through the openings 10a by means of a special injector J delivering the fluid product.

In more detail, the fluid product is conveyed to the injector J through a respective channel C1, C2.

Advantageously, this phase comprises the introduction of two separate fluid products in the pair of vials 7a, 7b.

For this purpose, the injector J is provided with two channels C1 and C2, each intended to deliver the respective fluid product; a first channel C1 delivers a first fluid product inside a first vial 7a and a second channel C2 delivers a second fluid product inside the vial 7b.

The bottom tangs 14 are finally sealed.

This phase comprises the welding of the vials 7a, 7b by pressing the bottom tangs 14 between at least two welding elements P.

The result is a strip 6 of containers for fluid products of the medical, pharmaceutical, cosmetic type or the like, which comprises at least one pair of vials 7a, 7b, wherein each vial 7a, 7b has at least one hollow body 9, defining the containment chamber 10 of the fluid product and comprising the substantially flat first wall 8a and the substantially curved second wall 8b.

The hollow bodies 9 of the aforementioned pair of vials 7a, 7b are joined together along the folding attachment portion 11.

In particular, the folding attachment portion 11 is arranged longitudinally with respect to the vials 7a, 7b.

Each vial 7a, 7b is also provided with a closed delivery neck 12 and with a bottom tang 14 for the introduction of the fluid product in the containment chamber 10.

In particular, the bottom tangs 14 are sealed by corresponding welding lips 15.

In addition, each vial 7a, 7b is provided with a closure cap 13 that can be removed by tearing it off from the delivery neck 12.

According to the embodiment of the present process shown in the figures, the forming mould 3 is shaped so as to form a strip 6 comprising a plurality of pairs of vials 7a, 7b.

For this purpose, the forming mould 3 is shaped in such a way as to provide the strip 6 with at least one breakable attachment portion 16 positioned between one pair of vials 7a, 7b and at least one adjacent pair of vials.

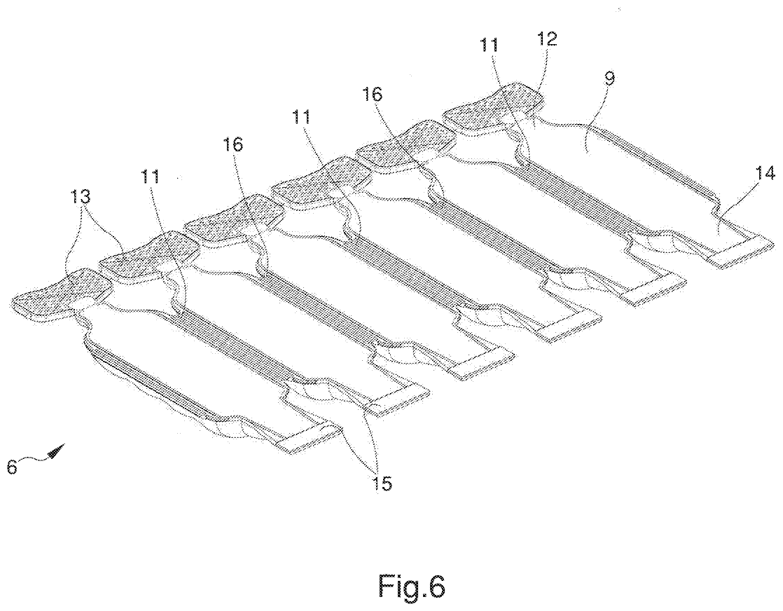

Substantially, as shown in FIG. 6, the strip 6 thus obtained comprises a plurality of pairs of vials 7a, 7b associated with each other at at least one breakable attachment portion 16.

Similar to the folding attachment portion 11, the breakable attachment portion 16 is also positioned longitudinally to the vials 7a, 7b.

According to this embodiment moreover, the injector J is defined so that the two fluid products are delivered alternately in the various pairs of vials 7a, 7b.

The process comprises the phase of removing a pair of vials 7a, 7b from the strip 6 by tearing off at least one breakable attachment portion 16.

Finally, the pair of vials 7a, 7b is folded around the folding attachment portion 11 between an extended configuration, wherein the first walls 8a are substantially coplanar, and a configuration of use, wherein the first walls 8a are facing each other and brought close to each other to obtain at least one dual-chamber container 1.

In other words, the folding attachment portion 11 defines an axis of rotation A around which the pair of vials 7a, 7b, containing the two separate fluid products, can be folded towards the aforementioned configuration of use so as to form the dual-chamber container 1.

In particular, in the extended configuration, the pair of vials 7a, 7b can be easily packaged, while in the configuration of use it allows the simultaneous administration of the two fluid products.

It cannot however be ruled out that the pair of vials 7a, 7b can also be packaged in its configuration of use.

It should also be noted that, in the configuration of use, the delivery necks 12 are also placed next to each other in order to allow a better administration of the two fluid products.

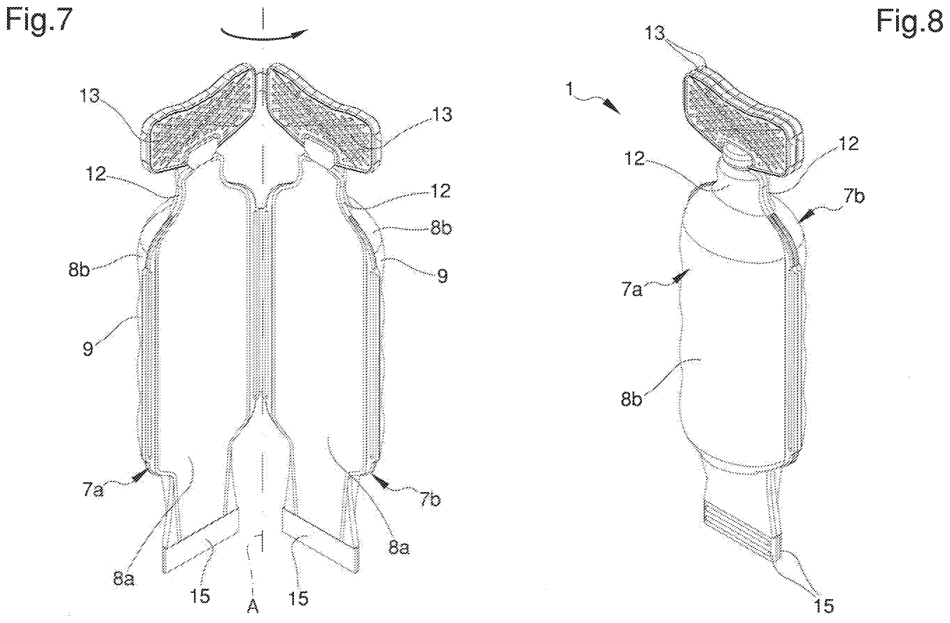

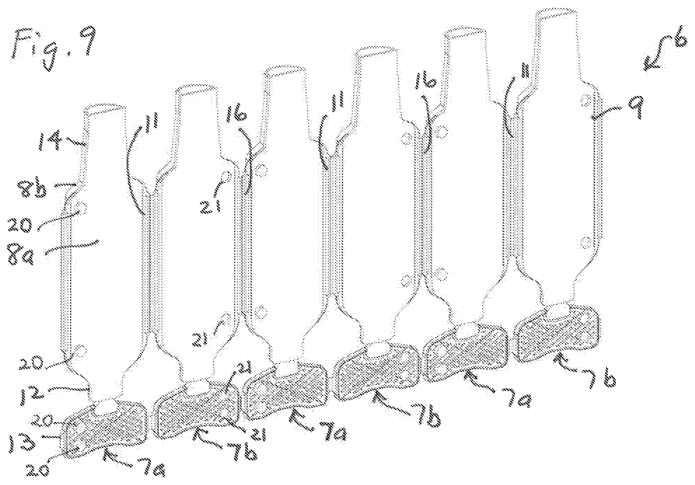

As shown in FIGS. 7 and 8, in fact, the first walls 8a also extend at the delivery necks 12 and allow the latter to be placed side by side.

Once the closure caps 13 have been removed from the delivery necks 12, corresponding delivery ports are obtained, side by side, which allow for the simultaneous delivery of the two fluid products.

In an embodiment of the present process, not shown in detail in the figures, the forming mould 3 can be shaped in such a way that the pair of vials 7a, 7b is also provided with joining means adapted to keep the first walls 8a side by side, in the configuration of use.

The joining means may consist, e.g., of a series of interlocking portions obtained on the vials 7a, 7b from symmetrically opposite sides to each other with respect to the axis of rotation A, so as to interlock with each other when the vials 7a, 7b are placed in the configuration of use.

The joining means are intended to facilitate the union between the vials 7a, 7b and to allow an easy administration of the two fluid products.

The process according to the invention allows, therefore, manufacturing a dual-chamber container 1.

In this case, the container 1 is composed of a pair of vials 7a, 7b in the configuration of use, wherein the two containment chambers 10 form an individual double chamber and the first walls 8a represent a separating partition of the aforementioned dual chamber.

Conveniently, the phases of the present process can be carried out in a different order from that described and shown in the embodiment of the figures.

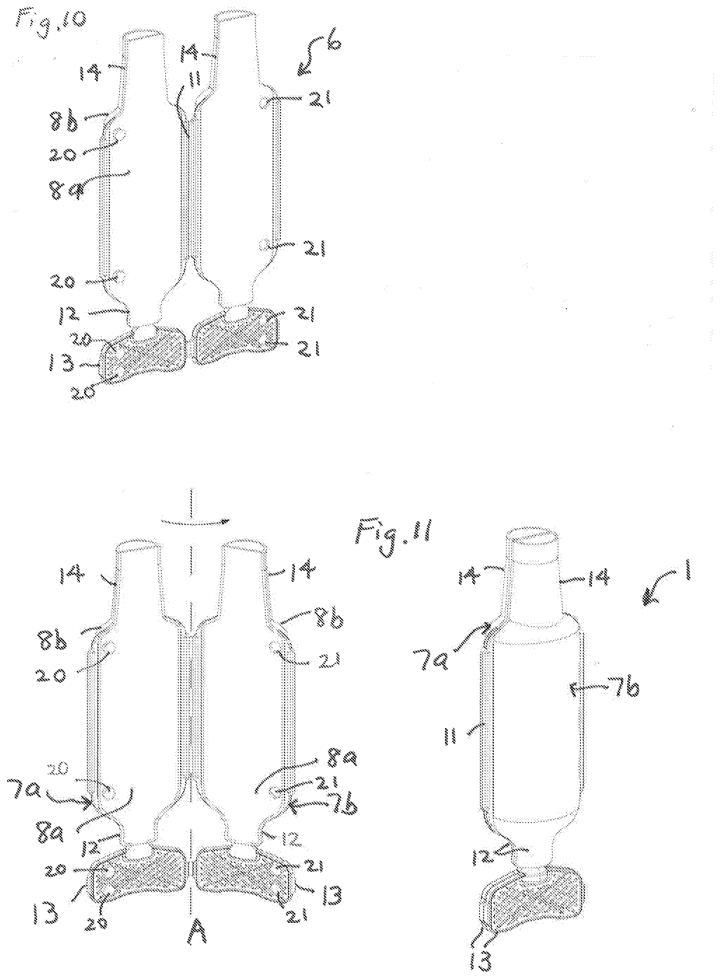

In particular, in a further embodiment of the present invention shown in FIGS. 9-14, the removal of the pair of vials 7a, 7b from the strip 6 and the folding of the vials along the folding attachment portion 11 may occur prior to the phase of sealing the bottom tangs 14.

Substantially, in this embodiment of FIGS. 9-14, the sealing of vials 7a, 7b occurs when the first walls 8a are already positioned side by side together.

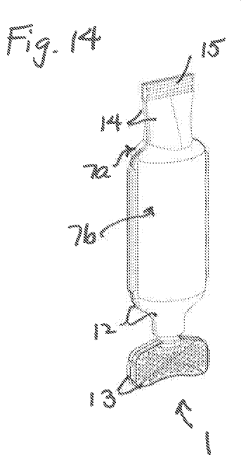

This way, during the heating of the bottom tangs 14 both the closure of the vials 7a, 7b and the formation of the dual-chamber container 1 are obtained at the same time as shown in FIG. 13.

In fact, the melting of the plastic material leads to the formation of a single welding lip 15 which, moreover, helps to keep the vials 7a, 7b joined together forming the dual-chamber container 1.

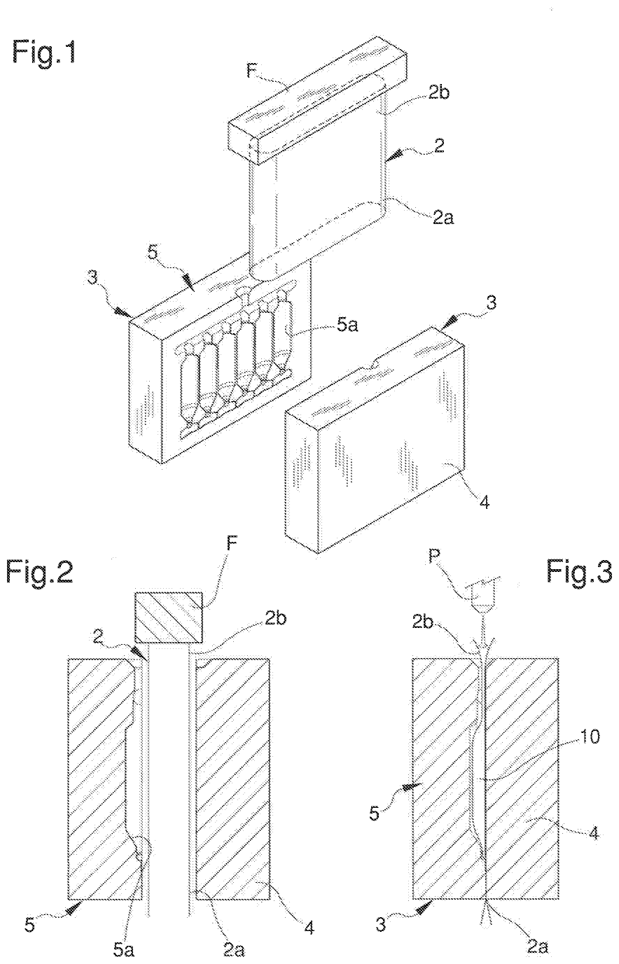

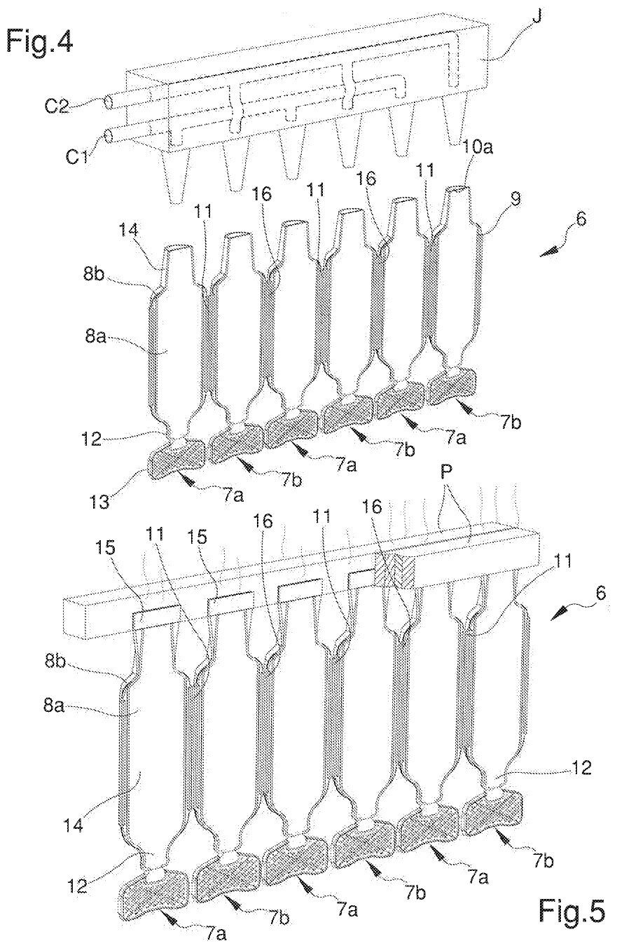

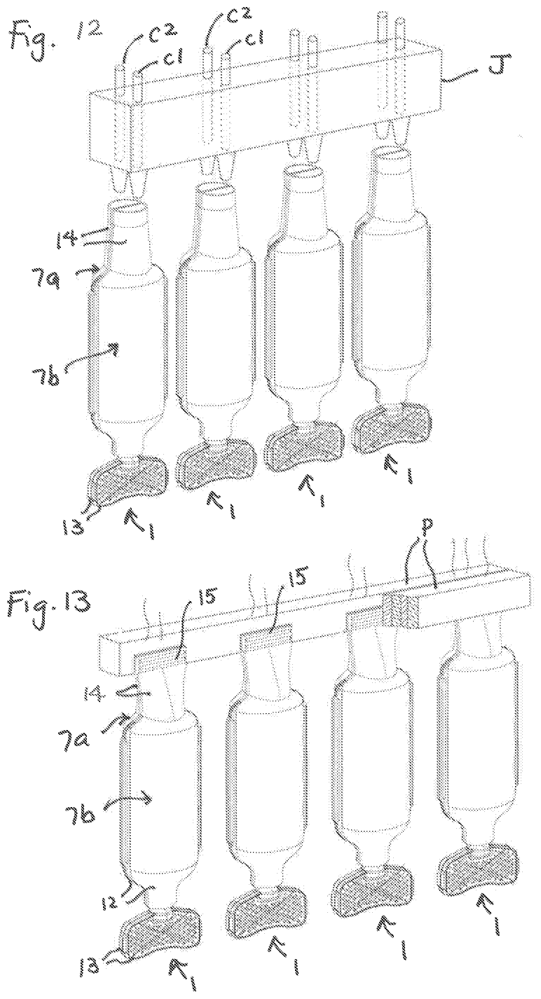

According to another embodiment of the invention illustrated in FIGS. 9-14, interlocking members (20, 21) are provided on the first walls (8a) (see FIG. 9), a pair of vials (7a, 7b) are first separated from the strip (6) (see FIG. 10), folded together (see FIG. 11) and attached together via the interlocking portions (20, 21), filled with fluid product through the bottom tangs (14), and the bottom tangs (14) then sealed (FIG. 13) to form the final dual-chamber container (1) (FIG. 14). The interlocking portions shown are mating pins (20) and holes (21) that fit into and around one another to hold the pair of vials together during filling (FIG. 12) and sealing of the bottom tangs (FIG. 13). However, other types of interlocking members may be used, or the interlocking members may be omitted in alternative embodiments. In the embodiment of FIGS. 9-14, a single welding lip 15 is formed to seal together the tangs (14, 14) of the vials (7a, 7b) in the container (1), as opposed to the pair of weld lips (15, 15) formed in the embodiment of FIGS. 1-8.

It has in practice been ascertained that the described invention achieves the intended objects and in particular it is underlined that the process according to the invention allows the manufacture of dual-chamber containers with simple and immediate practical application.

Moreover, the present process allows obtaining dual-chamber containers in multilayer materials which are able to give particular properties and functions to the container itself.

1. Process for the manufacture of dual-chamber containers (1) for fluid products of the medical, pharmaceutical, cosmetic type or the like, comprising steps of:
shaping through a die (F) at least one layer of a plastic material to form at least one substantially tubular semi-finished product (2) provided with a first extremity (2a) and with a second extremity (2b);
closing said semi-finished product (2) inside a forming mould (3) which comprises at least two half-shells (4, 5), said half-shells (4, 5) being shaped in such a way that, when said semi-finished product (2) is closed in the forming mould, the first extremity (2a) of the semi-finished product (2) is closed while the second extremity remains in fluidic connection with a pneumatic nozzle (P);
blowing an expansion gas through said second extremity (2b) to make said semi-finished product (2) adhere to said forming mould (3) to form at least one strip (6) comprising at least one pair of vials (7a, 7b), wherein each of said vials (7a, 7b) is provided with:
at least one hollow body (9), defining at least one containment chamber (10) of a fluid product and comprising a substantially flat first wall (8a) and a substantially curved second wall (8b);
at least one closed delivery neck (12); and
at least one open bottom tang (14);
and wherein said hollow bodies (9) are joined together through a folding attachment portion (11);
introducing said fluid product into said containment chambers (10) through said bottom tangs (14);
sealing said bottom tangs (14);
folding said pair of vials (7a, 7b) around said folding attachment portion (11) between an extended configuration, wherein said first walls (8a) are substantially coplanar, and a configuration of use, wherein said first walls (8a) are facing each other and brought close to each other to obtain at least one dual-chamber container (1).

2. Process according to claim 1, wherein said forming mould (3) is shaped so as to provide each of said vials (7a, 7b) with a closure cap (13) that can be removed by tearing it off from said delivery neck (12).

3. Process according to one or more of the preceding claims, wherein said forming mould (3) is shaped so as to form a strip (6) comprising a plurality of said pairs of vials (7a, 7b).

4. Process according to claim 3, wherein said forming mould (3) is shaped in such a way as to provide said strip (6) with at least one breakable attachment portion (16) positioned between one of said pairs of vials (7a, 7b) and at least one adjacent pair of vials.

5. Process according to claim 4, including a step of removing a pair of vials (7a, 7b) from said strip (6) by tearing said at least one breakable attachment portion (16).

6. Process according to one or more of the preceding claims, wherein said shaping comprises extruding said at least one layer of plastic material through said die (F).

7. Process according to claim 6, wherein said shaping comprises extruding at least two plastic materials through said die (F) to obtain a multilayer semi-finished product (2).

8. Process according to one or more of the preceding claims, wherein said introducing comprises the step of introducing two separate fluid products in said pair of vials (7a, 7b).

9. Process according to one or more of the preceding claims, wherein said sealing comprises the step of welding said vials (7a, 7b) by pressing said bottom tangs (14) between at least two welding elements.

10. Process according to one or more of the preceding claims, wherein the following said steps are performed in the following order:
introducing said fluid product into said containment chambers (10) through said bottom tangs (14);
sealing said bottom tangs (14);
folding said pair of vials (7a, 7b) around said folding attachment portion (11) between an extended configuration, wherein said first walls (8a) are substantially coplanar, and a configuration of use, wherein said first walls (8a) are facing each other and brought close to each other to obtain at least one dual-chamber container (1).

11. Process according to one or more of the preceding claims 1 to 9, wherein the following said steps are performed in the following order:
folding said pair of vials (7a, 7b) around said folding attachment portion (11) between an extended configuration, wherein said first walls (8a) are substantially coplanar, and a configuration of use, wherein said first walls (8a) are facing each other and brought close to each other to obtain at least one dual-chamber container (1);
introducing said fluid product into said containment chambers (10) through said bottom tangs (14); and
sealing said bottom tangs (14).

12. Process according to one or more of the preceding claims, wherein said first walls (8a) of said pair of vials include interlocking portions (20, 21), and said interlocking portions are brought into engagement for joining said pair of vials in the configuration of use.

13. A strip (6) of containers for fluid products of the medical, pharmaceutical, cosmetic type or the like, the strip comprising at least one pair of vials (7a, 7b), in which each of said vials (7a, 7b) is provided with:
at least one hollow body (9), defining at least one containment chamber (10) of a fluid product and comprising a substantially flat first wall (8a) and a substantially curved second wall (8b);
at least one closed delivery neck (12); and
at least one bottom tang (14) for the introduction of said fluid product in said containment chamber (10);
and wherein said hollow bodies (9) are joined together along a folding attachment portion (11) around which said pair of vials (7a, 7b) is foldable between an extended configuration, wherein said first walls (8a) are substantially coplanar, and a configuration of use, wherein said first walls (8a) are facing each other and brought close to each other to obtain at least one dual-chamber container (1).

14. Strip (6) according to claim 13, wherein each of said vials (7a, 7b) is provided with a closure cap (13) that can be removed by tearing it off from said delivery neck (12).

15. Strip (6) according to one or more of the preceding claims 13 to 14, wherein said bottom tangs (14) are sealed by corresponding welding lips (15).

16. Strip (6) according to one or more of the preceding claims 13 to 15, wherein the strip comprises a plurality of said pairs of vials (7a, 7b) associated with each other at at least one breakable attachment portion (16).

17. Strip (6) according to one or more of the preceding claims 13 to 16, wherein the strip is made of a multilayer plastic material.

18. Strip (6) according to one or more of the preceding claims 13 to 17, wherein said first walls (8a) of said pair of vials include interlocking portions (20, 21) for joining said pair of vials in the configuration of use.
